(19) United States
(12) Patent Application Publication
(10) Pub. No.: US 2026/0336565 A1
(43) Pub. Date: Oct. 29, 2026

(54) Closing device for a motor vehicle and motor vehicle including such a closing device

(71) Applicant: ADVANCED COMFORT SYSTEMS FRANCE S.A.S, Bressuire (FR)

(72) Inventor: Philippe CHARGE, Bressuire (FR)

(21) Appl. No.: 19/662,694

(22) Filed: Apr. 29, 2026

Related U.S. Application Data
(60) Provisional application No. 63/796,544, filed on Apr. 29, 2025.

(30) Foreign Application Priority Data
Apr. 29, 2025 (FR) 2504541

(51) Int. Cl. B60S 1/02; H05B 3/84

(52) U.S. Cl. CPC B60S 1/026; H05B 3/84; H05B 2203/016

(57) ABSTRACT

A closing device for a motor vehicle, includes a fixed part; a movable part including a heating grid, and electrical connection means electrically connected to the heating grid and designed to cooperate with an electrical power source, wherein the electrical connection means take the form of an electrical ribbon cable that has a flexible portion that forms a loop of a length that increases or decreases as the movable part moves from a first position to a second position, or vice versa.

### FIELD OF THE INVENTION

The field of the invention is the design and manufacture of closing devices for motor vehicles.

More specifically, the invention relates to a closing device for a motor vehicle that includes means for electrical connection such as cables or ribbon cables.

### STATE OF THE ART

To provide visibility and enable a ventilation of the passenger compartment, motor vehicles include closing devices such as glazed elements, which fit into apertures formed in the frame or a door of the vehicle.

The Applicant has developed closing devices, generally referred to as “flush-mount windows”, which are intended to be installed, in particular by bonding on the edges of an aperture, and which include a fixed part on which at least one movable part is mounted.

Such a closing device includes, in a known manner, a fixed part provided with guide means, or rails, which support and guide a movable part that is mounted so as to be slidable on these rails.

In the case of vehicles that include a passenger cabin and a transport surface mounted behind the cabin, also known as pick-ups or flatbed trucks, the cabin is provided with a closing device on its rear wall.

The movable part can be opened to allow communication between the interior of the cabin and the outside, i.e. the flatbed or storage space.

The fixed part and the movable part include or comprise a glazed surface area that allows a visibility of the outside environment from inside the cabin.

In the case of pick-up trucks, and more generally the devices mounted at the rear of the vehicle, the different glazed portions of the closing device are provided with heating grids that allow an electric current to circulate, wherein the electric current generates heat that spreads throughout the part containing the heating grid so as to provide a defogging and/or defrosting function.

The heating grids are supplied with power by electrical connection means.

However, the mobility of the movable part makes it necessary to ensure continuity in the electrical power supply to the heating grid regardless of the position of the movable part.

To address this issue, a first known technique consists in connecting the fixed part to an electrical power supply and using the heating grid of the fixed part to supply the movable part.

This solution has a major drawback in terms of ensuring electrical conductivity.

In fact, if the heating grid of the fixed part malfunctions, the electrical grid of the movable part can no longer be supplied, which then prevents the effective and rapid defogging of the closing device.

Another known solution is to connect each heating grid to the source of the vehicle via electrical cables.

While this solution makes it possible to minimize the effects of a malfunction on the defrosting and/or defogging of the closing device, it nevertheless has a major drawback.

Indeed, the use of cables to supply power to the heating grid of the movable part causes a premature wearing of said cable with the movement of the movable part.

In fact, the movement of the movable part over time tends to cause the electrical cable to become tangled, and such tangling can damage the copper wires in the cable and cause them to break.

This is because the power cable lies in the path travelled by the movable panel, which makes it necessary to guide the cable with dedicated mechanisms that generate additional costs and compromise the reliability of the closing device, since these dedicated mechanisms can fail.

### OBJECTS OF THE INVENTION

A particular object of the invention is to overcome the drawbacks of the prior art.

More specifically, one object of the invention is to provide a closing device with a reliability that is increased compared to the solutions of the prior art.

A further object of the invention is to provide such a closing device that offers increased protection of the electrical power-supply means.

A further object of the invention is to provide such a closing device that is easy to install and to maintain.

### SUMMARY OF THE INVENTION

These objects, as well as others that will become apparent in the following, are achieved by the invention, which relates to a closing device for closing an aperture at the rear of a motor vehicle, wherein the closing device is equipped with defrosting grids and includes a fixed assembly in which an opening is defined between a glazed left part and a glazed right part of the fixed assembly, and a glazed movable part, which is guided along a lower guide rail and an upper guide rail supported by the fixed assembly, and which is movable between a first position in which the movable part closes the opening, and a second position in which the movable part vacates the opening and at least partially overlaps the left part or the right part of the fixed assembly, wherein the movable part has a defrosting grid,
characterized in that the closing device includes a flexible electrical ribbon cable with two ends, a first end with at least a first connector for connection to the movable panel, and a second end with at least a second connector for connection to electrical power-supply terminals,
wherein the electrical ribbon cable has at least a first fold that defines two ribbon-cable portions, a first ribbon-cable portion that has the at least one first connector and that extends substantially perpendicular to one of the rails, and a second ribbon-cable portion that has the at least one second connector and that extends substantially parallel to said rail and that forms a loop so as to define two bands that are connected by a 180° arc, wherein the loop exhibits a variable distance between the at least one second connector and the arc, which increases as the movable part moves from its first position to its second position and decreases as the movable part moves from its second position to its first position, or vice versa.

The terms “perpendicular” and “parallel” encompass a margin of +/−10°. In other words, “perpendicular” denotes an angle between two elements between 80° and 100° or between 260° and 280°, and “parallel” denotes an angle between two elements between −10° and 10° or between 170° and 190°.

It should be noted that the terms “parallel” and “perpendicular” encompass a margin of +/−10°.

The closing device provides, as will be explained in the following, an improved reliability over known solutions, while keeping costs low.

The use of a looped electrical ribbon cable thus makes it possible to limit the risk of twisting and consequently of a premature wearing of the electrical connection means.

Indeed, in the closing devices of the prior art, conventional cables tend to twist with the use of the closing device over time, which results, eventually, in their breaking and thus in a breakdown of the closing device.

The loop shape enables a rolling and unrolling of the ribbon cable so as to prevent twisting phenomena and thereby increase the reliability of the closing device by preventing the premature breaking of the electrical connection means.

Furthermore, this results in no or a slight increase in manufacturing cost compared to the prior art, as any increase is offset by the enhanced reliability resulting from the use of the looped ribbon cable.

According to an advantageous aspect, the movable part is mounted on two shuttles, each sliding in one of the rails, wherein said movable part can move in relation to the shuttles in order to move from a first plane defined by the fixed assembly, when the movable part closes the opening, to a sliding plane parallel to the closing plane, wherein the first ribbon-cable portion is dimensioned and mounted so as to follow, in the rail and the shuttle, a movement of the movable part in relation to the shuttle during a transition from the closing plane to the sliding plane and vice versa.

Thanks to the presence of the two shuttles and the configuration of the flexible electrical ribbon cable, the movable part can be moved first perpendicularly to the lower and upper guide rails, and then along the lower and upper guide rails, or the other way around, without risk of damaging the electrical power supply to the defrosting grid of the movable part.

According to another advantageous aspect, at least the second ribbon-cable portion is placed in a compartment formed in the lower rail, under a guiding portion of the shuttle that has a floor capable of collecting and draining condensation and/or runoff water present on the fixed assembly or the movable part, so that the compartment is insulated from the condensation and/or runoff water.

According to another advantageous aspect, the shuttle has an interstice that allows the passage of the first ribbon-cable portion into the compartment.

According to another advantageous aspect, the passage has a length, parallel to the rail, of between 2 and 5 cm, so that the first ribbon-cable portion remains vertical during a movement of the movable part relative to the shuttle during a transition from the closing plane to the sliding plane and vice versa.

According to another advantageous aspect, the lower rail includes a compartment designed to receive the flexible portion of the electrical ribbon cable.

This compartment thus allows the electrical ribbon cable to be kept in a moisture-free environment, which further increases the reliability of the closing device.

Furthermore, the compartment defines a space in which the loop can be lengthened or shortened without risk of damaging the electrical ribbon cable.

According to another advantageous aspect, the fixed part also includes a casing with a protective portion that extends opposite and alongside the compartment in order to prevent access to the interior of the compartment.

The protective casing ensures the protection of the electrical ribbon cable by closing off the compartment, thus preventing the entry of objects that could compromise the integrity of the electrical ribbon cable as the loop changes.

According to another advantageous aspect, the movable part is coupled to a shuttle designed to cooperate with the lower rail.

The shuttle allows the movable part to move while ensuring protection of at least part of the electrical ribbon cable, as explained in the following.

According to another advantageous aspect, the shuttle includes an interstice that allows the passage of a lead portion of the electrical ribbon cable, which lead portion extends between the first end and the second end.

It is this interstice that allows the electrical ribbon cable to be protected by the shuttle, as explained in the foregoing.

Different variants of the interstice, which are easy to manufacture and implement, are described in the following.

According to another advantageous aspect, the interstice of the shuttle is formed by a slot formed in a projection of the shuttle.

According to another advantageous aspect, the interstice of the shuttle is formed by a cavity formed in the shuttle and a bar, wherein said bar extends opposite the cavity so as to hold the electrical ribbon cable in the cavity.

According to another advantageous aspect, the bar is joined to the shuttle by a stem and has a free end that defines a passage with the shuttle so as to allow the insertion of the electrical ribbon cable into the cavity.

According to another advantageous aspect, the bar is joined to the shuttle by a stem that forms a hinge and has a free end with a pin designed to fit into a recess of a complementary shape in the cavity to close the interstice.

According to another advantageous aspect, the interstice is formed by a cavity and two bars that are of one piece with the shuttle and that extend opposite the cavity so as to hold the electrical ribbon cable in the cavity, wherein each bar has a bevel and the bevels of each bar face each other so as to form a passage that allows the insertion of the electrical ribbon cable into the cavity.

According to another advantageous aspect, the interstice in the shuttle is formed by a cavity formed in the shuttle and a bar with two studs that are designed to cooperate with recesses of complementary shape formed in the shuttle so as to join the bar to the shuttle and hold the electrical ribbon cable in the interstice.

According to another advantageous aspect, the interstice has a movable or detachable wall with a functional position and with an installation position that allows the insertion of the first ribbon-cable portion into the interstice.

According to another advantageous aspect, the interstice has a wall with a slot, so as to allow the insertion of the first ribbon-cable portion into the interstice.

According to another advantageous aspect, the lower rail has or includes a protective side panel that closes off the compartment and that extends up to the interstice.

According to another advantageous aspect, the first ribbon-cable portion extends vertically between the protective side panel and a vertical edge of the rail.

According to another advantageous aspect, the device is adapted so that the first ribbon-cable portion enters the compartment along an edge of the compartment that is at a distance from the fixed assembly.

According to another advantageous aspect, the first portion of the electrical ribbon cable has a second fold between the first fold and the at least one first connector, wherein the second fold divides the first portion into a first sub-portion located between said at least one first connector and said second fold, and a second sub-portion located between said second fold and said first fold, wherein the first sub-portion extends at an angle of between 45° and 135° relative to the second sub-portion, wherein the second sub-portion extends perpendicular to said upper and lower guide rails.

According to another advantageous aspect, the second end of the ribbon cable has a single second connecting connector that is capable of connecting to a junction box that provides a positive power-supply terminal and a negative power-supply terminal.

The invention also relates to a motor vehicle including a closing device for closing an aperture at the rear of the vehicle, wherein the closing device is equipped with defrosting grids and includes a fixed assembly in which an opening is defined between a glazed left part and a glazed right part of the fixed assembly, and a glazed movable part, which is guided along a lower guide rail and an upper guide rail supported by the fixed assembly, and which is movable between a first position in which the movable part closes the opening, and a second position in which the movable part vacates the opening and at least partially overlaps the left part or the right part of the fixed assembly, wherein the movable part has a defrosting grid,

characterized in that the closing device includes a flexible electrical ribbon cable with two ends, a first end with at least one first connector for connection to the movable panel, and a second end with at least one second connector for connection to electrical power-supply terminals,

The electrical ribbon cable has at least one first fold that defines two ribbon-cable portions, a first ribbon-cable portion that has the at least one first connector and that extends substantially perpendicular to one of the rails, and a second ribbon-cable portion that has the at least one second connector and that extends substantially parallel to said rail and that forms a loop so as to define two bands that are connected by a 180°arc, wherein the loop exhibits a variable distance between the at least one second connector and the arc, which increases as the movable part moves from its first position to its second position and decreases as the movable part moves from its second position to its first position, or vice versa.

Such a vehicle offers lower manufacturing and maintenance costs than competing vehicles thanks to the presence of the closing device and its already described advantages.

According to an advantageous aspect, said vehicle includes a passenger cabin and a transport space (also called transport area) mounted behind the cabin, wherein said device is a rear closing device of the cabin.

As explained above, such a vehicle offers lower manufacturing and maintenance costs than competing models thanks to the presence of the closing device and its already described advantages.

In summary, the invention relates to a closing device for closing an aperture at the rear of a motor vehicle, wherein the closing device is equipped with defrosting grids and includes a fixed assembly in which an opening is defined between a glazed left part and a glazed right part of the fixed assembly, and a glazed movable part, which is guided along a lower guide rail and an upper guide rail supported by the fixed assembly, and which is movable between a first position in which the movable part closes the opening, and a second position in which the movable part vacates the opening and at least partially overlaps the left part or the right part of the fixed assembly, wherein the movable part has a defrosting grid,
wherein the closing device includes a flexible electrical ribbon cable with two ends, a first end with at least a first connector for connection to the movable panel, and a second end with at least a second connector for connection to electrical power-supply terminals,
wherein the electrical ribbon cable has at least a first fold that defines two ribbon-cable portions, a first ribbon-cable portion that has the at least one first connector and that extends substantially perpendicular to one of the rails, and a second ribbon-cable portion that has the at least one second connector and that extends substantially parallel to said rail and that forms a loop so as to define two bands that are connected by a 180° arc, wherein the loop exhibits a variable distance between the at least one second connector and the arc, which increases as the movable part moves from its first position to its second position and decreases as the movable part moves from its second position to its first position, or vice versa.

Other features can also be provided, alone or in combination, including the following:
the movable part is mounted on two shuttles, each sliding in one of the rails, wherein said movable part can move in relation to the shuttles in order to move from a first plane defined by the fixed assembly, when the movable part closes the opening, to a sliding plane parallel to the closing plane, wherein the first ribbon-cable portion is dimensioned and mounted so as to follow, in the rail and the shuttle, a movement of the movable part in relation to the shuttle during a transition from the closing plane to the sliding plane and vice versa;
at least the second ribbon-cable portion is placed in a compartment formed in the lower rail, under a guiding portion of the shuttle that has a floor capable of collecting and draining condensation and/or runoff water present on the fixed assembly or the movable part, so that the compartment is insulated from the condensation and/or runoff water;
the shuttle has an interstice that allows the passage of the first ribbon-cable portion into the compartment;
the passage has a length, parallel to the rail, of between 2 and 5 cm, so that the first ribbon-cable portion remains vertical during a movement of the movable part relative to the shuttle during a transition from the closing plane to the sliding plane and vice versa;
the interstice has a movable or detachable wall with a functional position and with an installation position that allows the insertion of the first ribbon-cable portion into the interstice;
the movable wall of the interstice includes two bars that define a passage, so as to allow the insertion of the first ribbon-cable portion into the interstice;
the lower rail has or includes a protective side panel that closes off the compartment and that extends up to the interstice;
the first ribbon-cable portion extends vertically between the protective side panel and a vertical edge of the rail;
the device is adapted so that the first ribbon-cable portion enters the compartment along an edge of the compartment that is at a distance from the fixed assembly;
the first portion of the electrical ribbon cable has a second fold between the first fold and the at least one first connector, wherein the second fold divides the first portion into a first sub-portion located between said at least one first connector and said second fold, and a second sub-portion located between said second fold and said first fold, wherein the first sub-portion extends at an angle of between 45° and 135° relative to the second sub-portion, wherein the second sub-portion extends perpendicular to said upper and lower guide rails,
the second end of the ribbon cable has a single second connecting connector that is capable of connecting to a junction box that provides a positive power-supply terminal and a negative power-supply terminal.

The invention also relates to a motor vehicle including a closing device for closing an aperture at the rear of the vehicle, wherein the closing device is equipped with defrosting grids and includes a fixed assembly in which an opening is defined between a glazed left part and a glazed right part of the fixed assembly, and a glazed movable part, which is guided along a lower guide rail and an upper guide rail supported by the fixed assembly, and which is movable between a first position in which the movable part closes the opening, and a second position in which the movable part vacates the opening and at least partially overlaps the left part or the right part of the fixed assembly, wherein the movable part has a defrosting grid,
wherein the closing device includes a flexible electrical ribbon cable with two ends, a first end with at least one first connector for connection to the movable panel, and a second end with at least one second connector for connection to electrical power-supply terminals,
wherein the electrical ribbon cable has at least one first fold that defines two ribbon-cable portions, a first ribbon-cable portion that has the at least one first connector and that extends substantially perpendicular to one of the rails, and a second ribbon-cable portion that has the at least one second connector and that extends substantially parallel to said rail and that forms a loop so as to define two bands that are connected by a 180° arc, wherein the loop exhibits a variable distance between the at least one second connector and the arc, which increases as the movable part moves from its first position to its second position and decreases as the movable part moves from its second position to its first position, or vice versa.

Furthermore, said vehicle includes a passenger cabin and a transport space to the rear of the cabin, wherein said closing device is mounted in an aperture formed in a rear wall of the cabin.

### BRIEF DESCRIPTION OF THE DRAWINGS

Further features and advantages of the invention will become apparent from a perusal of the following description of preferred embodiments of the invention-intended as illustrative, non-limiting examples- and the attached drawings described in the following.

FIG. 1 is a schematic illustration of a vehicle including a closing device according to the invention.

FIG. 2 is a schematic perspective illustration of a closing device according to the invention.

FIG. 3 is a schematic perspective illustration of an electrical ribbon cable of the closing device according to the invention.

FIG. 4 is a schematic illustration of a detail of the closing device according to the invention, which illustrates the connection of the electrical ribbon cable of FIG. 3 to a movable part.

FIG. 5 is a schematic illustration of a detail of a first embodiment of a closing device according to the invention in a longitudinal section.

FIG. 6 is a schematic illustration of a detail of a second embodiment of a closing device according to the invention in a longitudinal section.

FIG. 7 is a schematic illustration of a detail of a third embodiment of a closing device according to the invention in a longitudinal section.

FIG. 8 is a schematic illustration of a detail of a first embodiment of a closing device according to the invention in cross section.

FIG. 9 is a schematic illustration of a detail of a second embodiment of a closing device according to the invention in cross section.

FIG. 10 is a schematic illustration of a detail of a third embodiment of a closing device according to the invention in cross section.

FIG. 11 is a schematic illustration of a detail of a fourth embodiment of a closing device according to the invention in cross section.

FIG. 12 is a schematic illustration of a detail of a fifth embodiment of a closing device according to the invention in cross section.

FIG. 13 is a schematic illustration of another embodiment of an electrical ribbon cable of the closing device according to the invention.

FIG. 14 is a schematic illustration of a detail of a movable panel of a closing device according to the invention.

FIG. 15 is a schematic illustration of a detail of a movable panel of a closing device according to the invention in cross section.

FIG. 16 is a schematic illustration of a first embodiment of a cover of a movable part of a closing device according to the invention.

FIG. 17 is a schematic illustration of a first embodiment of a cover of a movable part of a closing device according to the invention.

FIG. 18 is a schematic illustration of a first embodiment of a cover of a movable part of a closing device according to the invention.

### DETAILED DESCRIPTION

Equivalent elements are designated by equivalent reference signs in the different figures. In particular, structural and/or functional elements common to the different embodiments can have the same reference signs and can possess identical structural, dimensional and material properties.

In the following description, when reference is made to qualifiers of absolute position, such as the terms “front”, “rear”, “top”, “bottom”, “left”, “right”, etc., or relative position, such as “above”, “below”, “upper”, “lower”, etc., or to qualifiers of orientation, such as “horizontal”, “vertical”, etc., reference is made, unless otherwise specified, to the orientation shown in the figures. Unless otherwise specified, the expressions “about”, “approximately”, “substantially” and “of the order of” mean within a margin of 10%, preferably within a margin of 5%.

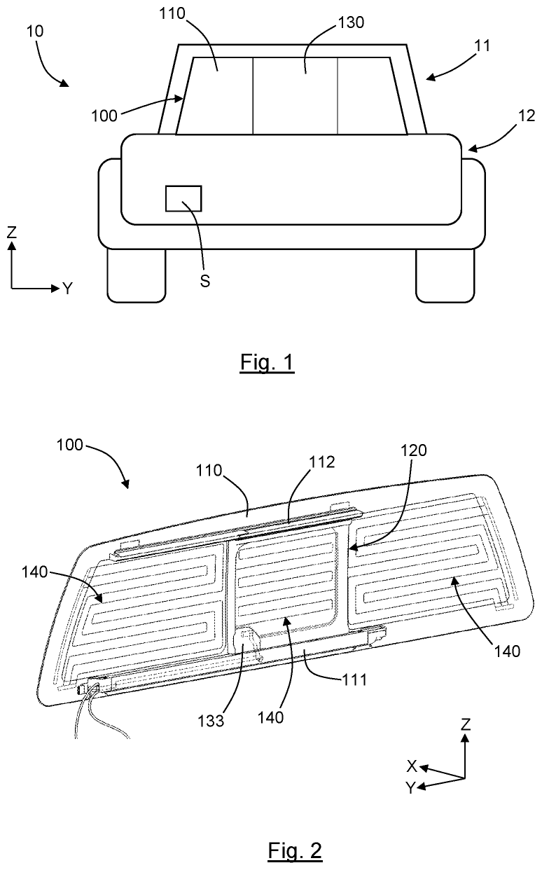

FIG. 1 illustrates a motor vehicle 10 including a closing device 100 according to the invention.

An orthogonal xyz coordinate system is defined in relation to the vehicle 10, which coordinate system includes three mutually perpendicular axes, namely:
an x-axis, which defines a longitudinal, horizontal direction, which coincides with the general direction of travel of the vehicle;
a y-axis, which defines a transverse, horizontal direction, which together with the x-axis defines a horizontal xy-plane, and
a z-axis, which defines a vertical direction perpendicular to the horizontal xy-plane.

As illustrated in FIG. 1, the vehicle 10 includes a passenger cabin 11 and a transport area 12 mounted behind the cabin 11. In the illustrated example, the vehicle 10 is a pick-up truck, but it could be a truck or a light truck that includes a skip or a flatbed.

The closing device 100 is a rear closing device of the cabin 11.

The vehicle 10 also includes an electrical power source S intended to supply electrical power to the closing device 100, as will be explained in the following. The source S is advantageously the battery of the vehicle 10. Alternatively, the source S could be an auxiliary source such as an accessory battery, or a photovoltaic surface supported on the vehicle 10 that makes it possible to generate electrical power that is potentially stored in a dedicated battery.

The closing device 100 will now be described with reference to FIGS. 2 to 12.

The closing device 100 includes:
a fixed part 110 with an opening 120 that allows communication between the interior and exterior of the cabin 11, and
a movable part 130.

As explained in the following, the movable part 130 is movable between a first position, called the closed position, in which the movable part 130 closes the opening 120, and a second position, called the open position, in which the movable part 130 vacates the opening 120 and at least partially overlaps the fixed part 110.

To facilitate the movement of the movable part 130 between its first position and its second position, the fixed part 110 has a lower guide rail 111. The lower guide rail 111 thus allows the guidance of the movement of the movable part 130.

Furthermore, the fixed part 110 includes an upper guide rail 112. The use of the upper guide rail 112 makes it possible to improve the guidance of the movement of the movable part 130, and thus the opening or closing of the closing device.

The movable part 130 is movable mainly in translation along the y-axis as defined above, as well as along the x-axis to enable the offset movement characteristic of flush-mount windows as described in the following.

The fixed part 110 and the movable part 130 include at least one glazed surface. In the example illustrated in the figures, the fixed part and the movable part are formed by glazed surfaces.

The closing device 100 also includes defrosting and/or defogging means, or defrosting and/or defogging grids, for example for at least a part of the glazed surfaces.

These defogging means take the form of heating grids 140.

These heating grids 140 are powered by the electrical power source S.

These heating grids 140 are formed by an electrical resistor fixed on each fixed part 110 and on the movable part 130.

More specifically, with regard to the movable part 130, the closing device includes electrical connection means that connect the source S to the heating grid 140.

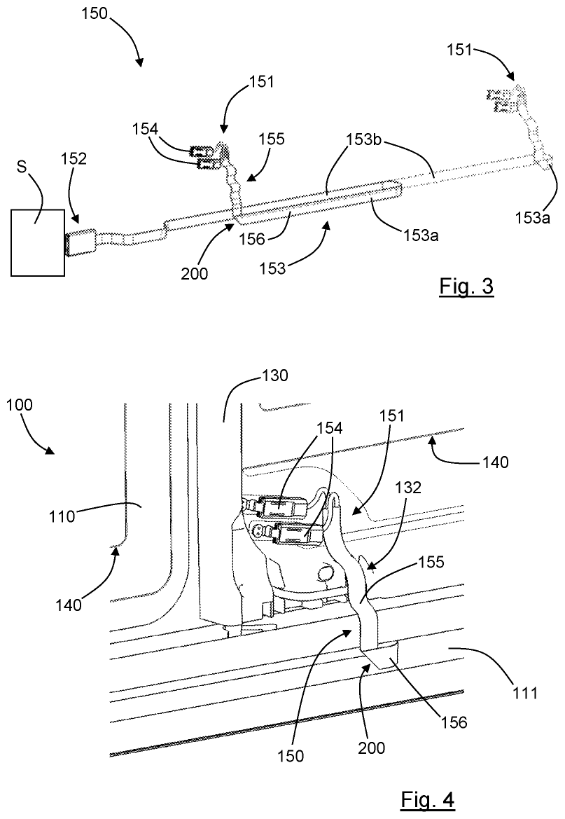

With reference to FIG. 3, the electrical connection means take the form of an electrical ribbon cable 150.

It should be noted that the ribbon cable 150 is intended to supply power exclusively to the heating grid 140 of the movable part 130.

The electrical connection means, i.e. the electrical ribbon cable 150, are thus electrically connected to the heating grid 140 of the movable part 130 by a first end 151 and are intended to cooperate with the electrical power source S by a second end 152.

The ribbon cable 150 has a flexible portion 153 that includes the second end 152.

As illustrated in FIG. 2, the flexible portion 153 extends underneath the lower rail 112 and forms a loop. In other words, the ribbon cable 150 folds back on itself so as to form two bands 153a, 153b, which are connected by a 180° arc that defines a loop of a variable length, the variable length also being referred to as a variable distance.

The variable length, or variable distance, of the loop is defined by the variation in length of each band 153a, 153b.

More specifically, the length or distance of the loop increases as the movable part 130 moves from its first position to its second position (illustrated by the solid lines in FIG. 3) and decreases as the movable part 130 moves from its second position to its first position (illustrated by the dashed lines in FIG. 3).

In other words, when the movable part 130 moves from its first position to its second position, the length of a first band 153a increases while the length of a second band 153b decreases. Conversely, when the movable part 130 moves from its second position to its first position, the length of the first band 153a decreases while the length of the second band 153b increases.

More specifically, the second portion 156 of the first band 153a increases or decreases in length as a function of the direction of movement of the movable part 130, while the length of the first portion 155, i.e. the lead portion 155, remains unchanged or virtually unchanged.

In a reversed mounting configuration, not illustrated in the figures, the length of the second portion 156 of the loop increases as the movable part 130 moves from its second position to its first position (illustrated by the solid lines in FIG. 3) and decreases as the movable part 130 moves from its first position to its second position (illustrated by the dashed lines in FIG. 3).

Furthermore, the first end 151 of the electrical cable 150 has a connecting portion designed to be coupled to the heating grid 140 of the movable part 130 via connecting plugs 154, or connectors 154.

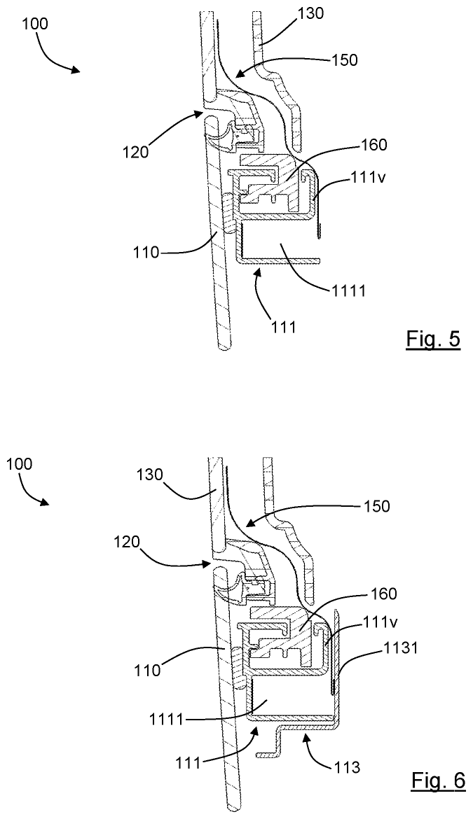

The lower guide rail 111 will now be described in more detail in the following with reference to FIGS. 5 to 12.

As illustrated in FIG. 5, the lower rail 111 has a compartment 1111 (also referred to as a dry groove) designed to receive the flexible portion 153 of the electrical ribbon cable 150. The compartment 1111 is located underneath a surface over which water, in particular rainwater, can flow and be drained by appropriate means. In other words, the compartment 1111 cannot be reached by water from outside the cabin 11.

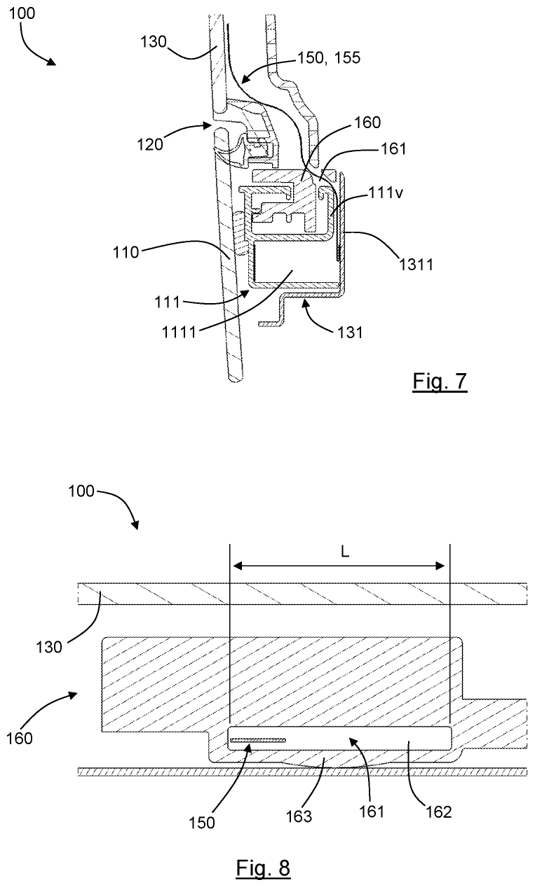

To keep the flexible portion 153 in the compartment 1111 and prevent access to the interior of the compartment 1111, the fixed part 110 also includes a casing 113 with a protective portion 1131, also called a protective side panel, which extends opposite and alongside the compartment 1111. The casing 113 is, for example, supported on the fixed part 110, for instance by being supported on the lower rail 111. According to a variant embodiment, the casing 113 and the lower rail 111 are of one piece. In other words, the lower rail 111 and the casing 13 form one and the same piece or a one-piece part. Thus, the lower rail 111 has or includes a protective side panel, i.e. the protective portion 1131, to close the compartment, said protective portion 1131 extending up to the interstice 161 as illustrated in FIG. 7.

As shown in FIGS. 6 and 7, the first ribbon-cable portion extends vertically between the protective side panel and a vertical edge 111v of the rail.

The vertical edge 111v of the rail is at a distance from the fixed assembly 110 so that the first portion of the ribbon cable 150, i.e. the lead portion 155, enters the compartment 1111 along an edge of the rail 111 at a distance from the fixed assembly 110. This keeps the ribbon cable 150 away from any water present, in particular water running down the outside of the fixed assembly 110.

When the movable part 100 is moved between its first position and its second position, the variation in length of the loop of the flexible portion 153 occurs in the compartment 1111.

Still with reference to FIGS. 5 to 12, the movable part 130 is coupled to a shuttle 160 designed to cooperate with the lower rail 111.

The first portion 155 of ribbon cable 150, i.e. the lead portion 155, is dimensioned and mounted so as to follow, in the lower rail 111 and the shuttle 160, a movement of the movable part 130 relative to the shuttle 160 during a transition from the closing plane to the sliding plane and vice versa. The movable part 130 performs an offset movement during its movement, thanks to the shuttle 160.

As illustrated in FIG. 7, the shuttle 160 includes an interstice 161 that allows the passage of a lead portion 155 of the electrical ribbon cable 150. As shown in FIG. 8, this passage advantageously has a length L, measured parallel to the rail, of between 2 and 5 cm. The first ribbon-cable portion thereby remains vertical during a movement of the movable part relative to the shuttle during a transition from the closing plane to the sliding plane and vice versa.

This lead portion 155 extends between the first end 154 and the flexible portion 153.

The shuttle 160 thus moves along the y-axis to ensure the movement of the movable part 130 by cooperating with the lower rail 111.

Different embodiments of the interstice 161 will now be described with reference to FIGS. 8 to 12.

According to a first embodiment illustrated in FIG. 8, the interstice 161 of the shuttle 160 is formed by a slot 162 formed in a projection 163 of the shuttle 160.

According to a second embodiment, a third embodiment and a fourth embodiment respectively illustrated in FIGS. 9, 10 and 11, the interstice 161 of the shuttle 160 is formed by a cavity 164 formed in the shuttle 160 and a movable or detachable wall that takes the form of a bar 165.

The bar 165 is designed to extend opposite the cavity 164 to hold the electrical ribbon cable 150 in the cavity 164.

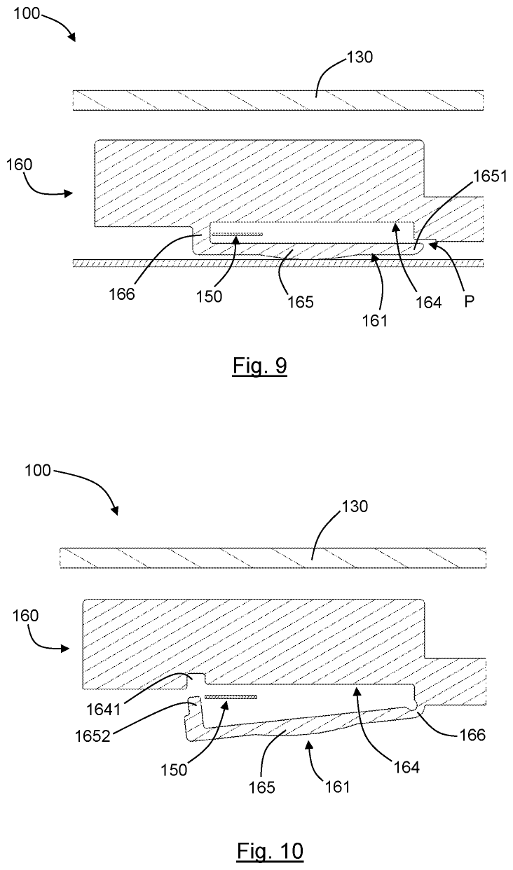

According to the second and third embodiments illustrated respectively in FIGS. 9 and 10, the bar 165 is joined to the shuttle by a stem 166.

According to the second embodiment illustrated in FIG. 9, the bar 165 has a free end 1651 that defines a passage P together with the shuttle 160 so as to allow the introduction of the electrical ribbon cable 150 into the cavity 164.

In this embodiment, the shuttle 160 and the bar 165 are of one piece and are made of a hard plastic material. In other words, the shuttle 160 and the bar 165 form a whole consisting of one piece and are made of a material of low elasticity, so that movement of the bar 165 relative to the shuttle 160 is limited or even impossible without risking breaking the stem 166.

According to the third embodiment illustrated in FIG. 10, the stem 166 forms a hinge. The bar 165 is thus rotatable relative to the shuttle 160.

Furthermore, the bar 165 has, at its free end 151, a pin 1652 designed to fit into a recess 1641 of a complementary shape. The recess is located in the cavity 164. The insertion of the pin 1652 into the recess 1641 allows the interstice 161 to be closed off in order to keep the ribbon cable 150 captive in the interstice 161.

According to the fourth embodiment illustrated in FIG. 11, the bar 165 has two studs 1653 designed to engage with recesses 1642 of complementary shape formed in the shuttle 160. More specifically, the recesses 1642 delimit the cavity 164 laterally.

The engagement of the studs 1653 in the recesses 1642 allows the bar 165 to be joined to the shuttle 161 so as to form the interstice 161 and hold the electrical ribbon cable 150 in the interstice 161.

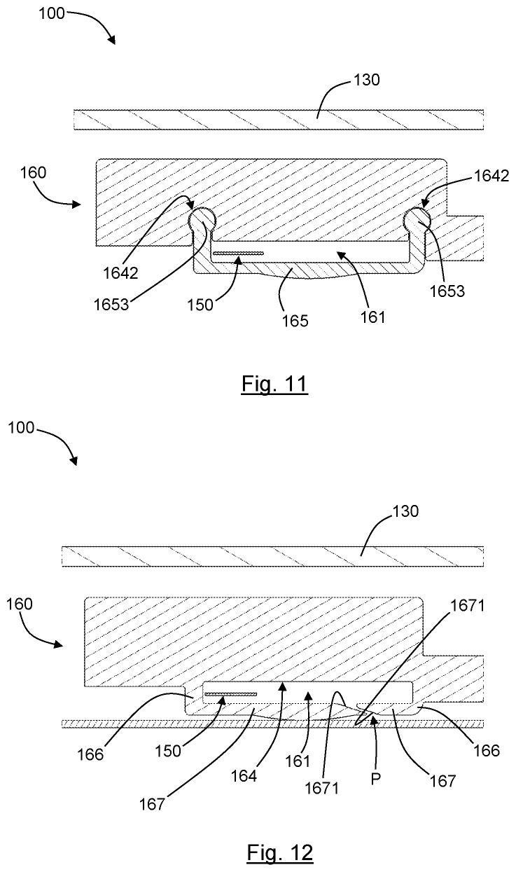

According to the fifth embodiment illustrated in FIG. 12, the movable wall of the interstice 161 includes two bars 167 of one piece with the shuttle 160. The bars are connected to the shuttle 160 via a leg 168.

The two bars 167 extend opposite the cavity 164 so as to hold the electrical ribbon cable 150 in the cavity 164.

Each bar 167 has a bevel 1671. The bevels 1671 of each bar 167 face each other to form a passage P that allows the introduction of the electrical ribbon cable 150 into the cavity 164.

In this embodiment, the shuttle 160 and the bars 167 are of one piece and are made of a hard plastic material. In other words, the shuttle 160 and the bars 167 form a whole consisting of one piece and are made of a material of low elasticity, so that movement of the bar 165 relative to the shuttle 160 is limited or even impossible without risking breaking the leg 168.

The closing device 10 described in the foregoing has numerous advantages, including the following.

The electrical ribbon cable 150 ensures that the electrical power supply to the heating grid 140 is maintained in all or virtually all circumstances, as the presence of the loop formed in the flexible portion 143 ensures a rolling and an unrolling of the ribbon cable 150 without the risk of it twisting and breaking. Compared to the solutions of the prior art, the ribbon cable 150 provides greater flexibility in the use of the movable part 130 by following the movement of the movable part, which causes the variation in length of the first band 153a and of the second band 153b.

This directly benefits the defrosting and/or defogging system, as the risks of a failure of the power supply to the heating grid 140 of the movable part 130 are limited, or even eliminated.

Furthermore, the electrical ribbon cable 150 is protected by the presence of the interstice 161 in the shuttle 160.

Indeed, the interstice 161 allows the lead portion 155 of the ribbon cable 150 to be held in a predetermined position, which forces the bands 153a and 153b to maintain their position and thus their length to vary as a function of the movement of the movable part 130.

In other words, the interstice 161 makes it possible to protect and hold the ribbon cable 150 in the shuttle 160, which enhances the reliability of the closing device 100.

Electrical protection thanks to the positioning of the ribbon cable in the compartment 1111.

In the prior art, the cable is positioned under the seal above the guide rail, so that there is a risk of seepage as well as of the cable being pinched and thus cut.

Furthermore, the closing device 100 described in the foregoing is easy to install and maintain.

The positioning of the electrical ribbon cable 150 in the compartment 1111 ensures a simplified assembly of the closing device 150 since it is not necessary to connect the heating grid 140 of the movable part 130 to that of a fixed part 110 and connection plugs 154 can be used to connect the electrical ribbon cable 150 to the heating grid 140 of the movable part 130.

Finally, in terms of maintenance, if a fault with the defogging and/or defrosting system is detected on the movable part 130, the fault can only originate at the heating grid 140 or the electrical ribbon cable 150, in which case repair is simple and quick, as it is sufficient to replace the defective component, unlike in the prior art where fault detection can be time-consuming and repair long and costly. This is particularly true when the heating grid of the movable part is electrically connected to the heating grid of the fixed part, since it is necessary in this case not only to replace the fixed part but also to make the connection between the heating grids of the fixed part and the movable part.

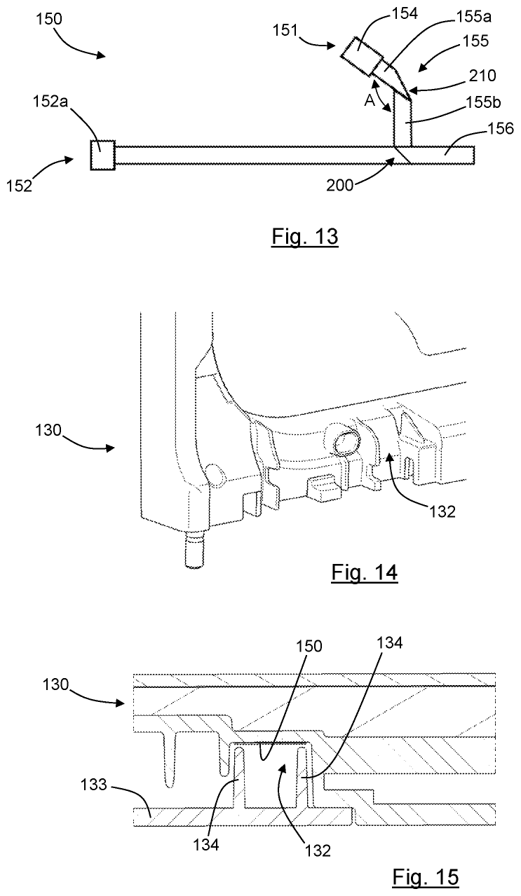

According to another embodiment shown in FIG. 13, the first portion of the electrical ribbon cable 150, i.e. the lead portion 155, has a second fold 210 between the first fold 200 and the at least one first connector 154.

The second fold 210 divides the first portion 155 into a first sub-portion 155a located between said at least one first connector 154 and said second fold 210, and a second sub-portion 155b located between said second fold 210 and said first fold 200.

The first sub-portion 155a extends parallel to said upper and lower guide rails 111, 112, and the second sub-portion 155b extends perpendicular to said upper and lower guide rails 111, 112.

This makes it possible to adapt the ribbon cable 150 to the type of movable panel 130, in particular to the type of connection that the movable panel 130 has, i.e. a vertical or horizontal plug-in connection.

As set out above, the terms “parallel” and “perpendicular” are to be understood as including a margin of +/−10°.

Thus, in FIG. 13, the first sub-portion 155a does not extend at an angle of 180° relative to the upper and lower guide rails 111, 112, but at an angle of between 35° and 55°.

Still with reference to FIG. 13, the second fold 210 thus allows the first sub-portion 155a to be positioned at an angle A of between 45° and 135° relative to the second sub-portion 155b. In this case, the second sub-portion 155b extends perpendicular to the guide rails.

With reference to FIGS. 3 and 13, the second end 152 of the ribbon cable has a single second connecting connector 152a that is capable of connecting to a junction box that provides a positive power-supply terminal and a negative power-supply terminal.

With reference to FIGS. 3 and 4, the first end 151 of the ribbon cable has two first connecting connectors 154a, each capable of connecting to a positive terminal and to a negative terminal of the defrosting grid 140 of the movable panel 130.

With reference to FIG. 13, the first end 151 of the ribbon cable 150 has a single first connecting connector 154 that is capable of connecting to a connecting element of the defrosting grid 140 of the movable panel 130.

With reference to FIG. 2, the closing device 100 includes a cover 133 for protecting the lead portion 155 of the ribbon cable 150 on the movable part 130.

With reference to FIGS. 4 and 14, the movable part 130 includes a groove 132 for positioning and holding at least part of the first portion 155, i.e. the lead portion 155, in position on the movable part 130.

As illustrated in FIGS. 15 to 18, the cover 133 includes ribs 134 designed to cooperate with the groove 132. The ribs 134 are designed to keep the lead portion 155 of the ribbon cable 150 in the groove 132 to prevent it from wearing out prematurely due to the opening and closing movements of the movable part 130.

With reference to FIGS. 15 and 16, the ribs have a height (measured along the z-axis) and a depth (measured along the x-axis) that extend over the entire height and depth of the groove 132.

This configuration is particularly expedient when the lead portion 155, i.e. the first portion, does not have a second fold 210.

With reference to FIG. 17, the ribs have a height (measured along the z-axis) less than the height of groove 132 and a depth (measured along the x-axis) that extends over the entire depth of groove 132.

This configuration is particularly expedient when the lead portion 155, i.e. the first portion, has a second fold 210.

Indeed, the second sub-portion 155b can be held in a vertical position in the shuttle 160 during the movement of the movable part 130, which increases the reliability of the device.

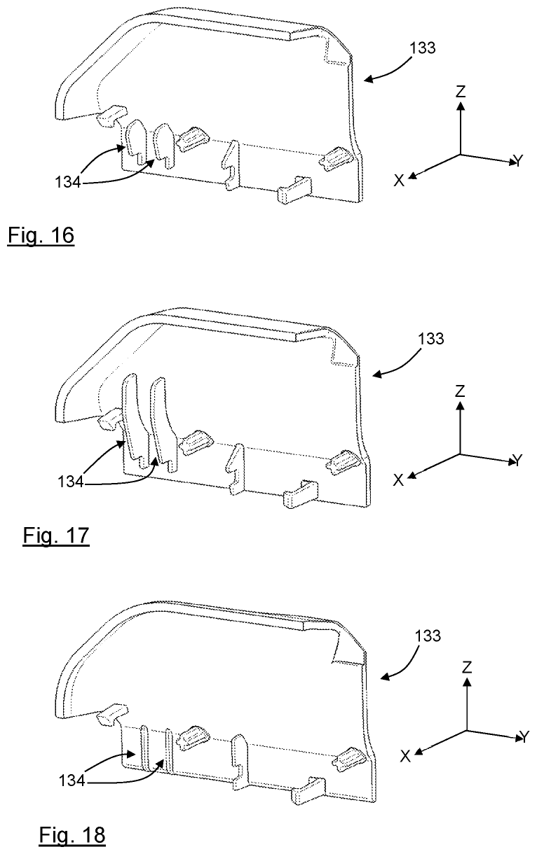

With reference to FIG. 18, the ribs have a height (measured along the z-axis) less than the height of the groove 132 and a depth (measured along the x-axis) less than the dimensions of the groove 132.

This configuration is particularly expedient when the lead portion 155, i.e. the first portion, has a second fold 210.

The entire lead portion 155, i.e. the first portion, can move freely to follow the movable panel 130 while being held in the groove 132.

Thanks to the presence of the two shuttles and the configuration of the flexible electrical ribbon cable, the movable part 130 can be moved first perpendicularly to the lower and upper guide rails and then along the lower and upper guide rails (offset movement), or vice versa, without risk of damaging the power supply to the defrosting grid of the movable part 130.

Furthermore, the presence of the second fold allows the ribbon cable to be adapted to the type of movable panel, for example to the type of connection that the movable panel has.

Finally, the one or more first connectors 154 allow the cable to be adapted to the configuration of the defrosting means of the closing device.

1. A closing device for closing an aperture at the rear of a motor vehicle, wherein the closing device is equipped with defrosting grids and includes a fixed assembly in which an opening is defined between a glazed left part and a glazed right part of the fixed assembly, and a glazed movable part, which is guided along a lower guide rail and an upper guide rail supported by the fixed assembly, and which is movable between a first position in which the movable part closes the opening, and a second position in which the movable part vacates the opening and at least partially overlaps the left part or the right part of the fixed assembly,
wherein the movable part has a defrosting grid,
wherein the closing device includes a flexible electrical ribbon cable with two ends, a first end with at least a first connector for connection to the movable panel, and a second end with at least a second connector for connection to electrical power-supply terminals,
wherein the electrical ribbon cable has at least a first fold that defines two ribbon-cable portions, a first ribbon-cable portion that has the at least one first connector and that extends substantially perpendicular to one of the rails, and a second ribbon-cable portion that has the at least one second connector and that extends substantially parallel to said rail and that forms a loop so as to define two bands that are connected by a 180° arc, wherein the loop exhibits a variable distance between the at least one second connector and the arc, which increases as the movable part moves from its first position to its second position and decreases as the movable part moves from its second position to its first position, or vice versa.

2. The device according to claim 1, wherein the movable part is mounted on two shuttles, each sliding in one of the rails, wherein said movable part can move in relation to the shuttles in order to move from a first plane defined by the fixed assembly, when the movable part closes the opening, to a sliding plane parallel to the closing plane, wherein the first ribbon-cable portion is dimensioned and mounted so as to follow, in the rail and the shuttle, a movement of the movable part in relation to the shuttle during a transition from the closing plane to the sliding plane and vice versa.

3. The device according to claim 1, wherein at least the second ribbon-cable portion is placed in a compartment formed in the lower rail, under a guiding portion of the shuttle that has a floor capable of collecting and draining condensation and/or runoff water present on the fixed assembly or the movable part, so that the compartment is insulated from the condensation and/or runoff water.

4. The device according to claim 3, wherein the shuttle has an interstice that allows the passage of the first ribbon-cable portion into the compartment.

5. The device according to claim 4, wherein the passage has a length, parallel to the rail, of between 2 and 5 cm, so that the first ribbon-cable portion remains vertical during a movement of the movable part relative to the shuttle during a transition from the closing plane to the sliding plane and vice versa.

6. The device according to claim 4, wherein the interstice has a movable or detachable wall with a functional position and with an installation position that allows the insertion of the first ribbon-cable portion into the interstice.

7. The device according to claim 4, wherein the movable wall of the interstice includes two bars that define a passage, so as to allow the insertion of the first ribbon-cable portion into the interstice.

8. The device according to claim 3, wherein the lower rail has or includes a protective side panel that closes off the compartment and that extends up to the interstice.

9. The device according to claim 7, wherein the first ribbon-cable portion extends vertically between the protective side panel and a vertical edge of the rail.

10. The device according to claim 1, wherein it is adapted so that the first ribbon-cable portion enters the compartment along an edge of the compartment that is at a distance from the fixed assembly.

11. The device according to claim 1, wherein the first portion of the electrical ribbon cable has a second fold between the first fold and the at least one first connector, wherein the second fold divides the first portion into a first sub-portion located between said at least one first connector and said second fold, and a second sub-portion located between said second fold and said first fold, wherein the first sub-portion extends at an angle of between 45° and 135° relative to the second sub-portion, wherein the second sub-portion extends perpendicular to said upper and lower guide rails.

12. The device according to claim 1, wherein the second end of the ribbon cable has a single second connecting connector that is capable of connecting to a junction box that provides a positive power-supply terminal and a negative power-supply terminal.

13. A motor vehicle including a closing device for closing an aperture at the rear of the vehicle, wherein the closing device is equipped with defrosting grids and includes a fixed assembly in which an opening is defined between a glazed left part and a glazed right part of the fixed assembly, and a glazed movable part, which is guided along a lower guide rail and an upper guide rail supported by the fixed assembly, and which is movable between a first position in which the movable part closes the opening, and a second position in which the movable part vacates the opening and at least partially overlaps the left part or the right part of the fixed assembly, wherein the movable part has a defrosting grid,
wherein the closing device includes a flexible electrical ribbon cable with two ends, a first end with at least one first connector for connection to the movable panel, and a second end with at least one second connector for connection to electrical power-supply terminals,
wherein the electrical ribbon cable has at least one first fold that defines two ribbon-cable portions, a first ribbon-cable portion that has the at least one first connector and that extends substantially perpendicular to one of the rails, and a second ribbon-cable portion that has the at least one second connector and that extends substantially parallel to said rail and that forms a loop so as to define two bands that are connected by a 180° arc, wherein the loop exhibits a variable distance between the at least one second connector and the arc, which increases as the movable part moves from its first position to its second position and decreases as the movable part moves from its second position to its first position, or vice versa.

14. The vehicle according to claim 13, wherein said vehicle includes a passenger cabin and a transport space to the rear of the cabin, wherein said closing device is mounted in an aperture formed in a rear wall of the cabin.
